(19) United States
(12) Patent Application Publication
(10) Pub. No.: US 2023/0409950 A1
(43) Pub. Date: Dec. 21, 2023

(54) EFFICIENT MOTIONAL-MODE CHARACTERIZATION FOR HIGH-FIDELITY TRAPPED-ION QUANTUM COMPUTING

(71) Applicants: IONQ, INC., College Park, MD (US); Duke University, Durham, NC (US)

(72) Inventors: Mingyu KANG, Durham, NC (US); Qiyao LIANG, Durham, NC (US); Ming LI, Silver Spring, MD (US); Yunseong NAM, North Bethesda, MD (US)

(21) Appl. No.: 18/202,270

(22) Filed: May 25, 2023

Related U.S. Application Data
(60) Provisional application No. 63/348,421, filed on Jun. 2, 2022.

(51) Int. Cl. G06N 10/40; G06N 10/60; G06N 10/20

(52) U.S. Cl. CPC G06N 10/40; G06N 10/60; G06N 10/20

(57) ABSTRACT

A method of using an ion trap quantum computer includes performing a first measurement of bright-state population of each ion in an ion chain, the each ion coupled to one of motional modes of the ion chain, while varying laser coupling frequency, computing mode frequency of the one of the motional mode based on the measured bright-state population in the first measurement, performing a second measurement of bright-state population of each ion in the ion chain, and computing coupling strength of the each ion and the one of the motional mode by fitting the bright-state population of the each ion measured in the second measurement to a value of the bright-state population computed based on the computed mode frequency of the one of the motional modes and non-zero temperature effect of the motional modes.

### CROSS-REFERENCE TO RELATED APPLICATIONS

This application claims priority to U.S. Provisional Application Ser. No. 63/348,421 filed Jun. 2, 2022, which is herein incorporated by reference in its entirety.

### BACKGROUND

### Field

The present disclosure generally relates to a method of performing entangling gate operations in a trapped ion based quantum computer, and more specifically, to a method of characterizing motional modes of a chain of ions.

### Description of the Related Art

In quantum computing, requirements for scalability include efficient characterization, calibration, and verification of the quantum computing system, in addition to high fidelity initialization, logic operations, and readout of the quantum computing system. In a trapped ion based quantum computer, quantum information encoded in trapped ions (qubits) are processed via motional modes (e.g., collective vibrations) of the ions, and thus efficient and accurate motional mode characterization leads to an efficient and accurate quantum computation.

Therefore, there is a need for methods and systems that allow an efficient and accurate characterization of motional modes of an ion chain.

### SUMMARY

Embodiments of the present disclosure provide a method of using an ion trap quantum computer. The method includes performing a first measurement of bright-state population of each ion in an ion chain comprising a plurality of ions at a fixed time duration, the each ion coupled to one of motional modes of the ion chain, while varying laser coupling frequency for coupling the each ion and the one of the motional modes, computing mode frequency of the one of the motional mode based on a frequency at which the bright-state population of the each ion measured in the first measurement is maximized, computing coupling strength of the each ion and the one of the motional modes by fitting the maximized bright-state population of the each ion measured in the first measurement to a value of the bright-state population computed based on the computed mode frequency of the one of the motional modes and non-zero temperature effect of the motional modes, performing a second measurement of bright-state population of each ion in the ion chain at a fixed time duration, each ion coupled to one of the motional modes, to which the each ion has not been coupled in the first measurement, while the laser coupling frequency for coupling the each ion and the one of the motional modes is fixed, and computing coupling strength of the each ion and the one of the motional mode by fitting the bright-state population of the each ion measured in the second measurement to a value of the bright-state population computed based on the computed mode frequency of the one of the motional modes and non-zero temperature effect of the motional modes.

Embodiments of the present disclosure also provide a method of using an ion trap quantum computer. The method includes performing a first measurement of bright-state population of each ion in an ion chain comprising a plurality of ions at a fixed time duration, the each ion coupled to one of motional modes of the ion chain, while varying laser coupling frequency for coupling the each ion and the one of the motional modes, computing mode frequency of the one of the motional mode based on a frequency at which the bright-state population of the each ion measured in the first measurement is maximized, performing a second measurement of bright-state population of each ion in the ion chain at a plurality of time durations, each ion coupled to one of the motional modes, while the laser coupling frequency for coupling the each ion and the one of the motional modes is fixed, and computing coupling strength of the each ion and the one of the motional mode by fitting the bright-state population of the each ion measured in the second measurement to a value of the bright-state population computed based on the computed mode frequency of the one of the motional modes and non-zero temperature effect of the motional modes.

Embodiments of the present disclosure further provide a quantum computing system. The quantum computing system includes an ion chain comprising a plurality of ions, each ion in the ion chain having two hyperfine states defining a qubit, a system controller, and a classical computer comprising a processor and non-volatile memory having a number of instructions stored therein which, when executed by the processor, causes the quantum computing system to perform operations including performing, by the system controller, a first measurement of bright-state population of each ion in the ion chain at a fixed time duration, the each ion coupled to one of motional modes of the ion chain, while varying laser coupling frequency for coupling the each ion and the one of the motional modes, computing, by the processor, mode frequency of the one of the motional mode based on a frequency at which the bright-state population of the each ion measured in the first measurement is maximized, performing, by the system controller, a second measurement of bright-state population of each ion in the ion chain, each ion coupled to one of the motional modes, while the laser coupling frequency for coupling the each ion and the one of the motional modes is fixed, and computing, by the processor, coupling strength of each ion in the ion chain and one of the motional modes of the ion chain based on based on the bright-state population measured in the first measurement, the bright-state population measured in the second measurement, the computed mode frequency of the one of the motional modes, and non-zero temperature effect of the motional modes.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of a trapped-ion quantum computing system according to one embodiment.

FIG. 2 depicts a flowchart illustrating a basic method of characterizing the Lamb-Dicke parameters according to one embodiment.

FIG. 3 depicts a flowchart illustrating improved method of characterizing the Lamb-Dicke parameters according to one embodiment according to one embodiment.

FIG. 4 illustrates examples of bright-state population at various evolution times according to one embodiment.

FIGS. 5A and 5B illustrate examples of time evolution of average bright-state population according to one embodiment.

FIGS. 6A and 6B illustrate examples of mean relative errors in estimating the Lamb-Dicke parameters according to one embodiment.

FIG. 7 illustrates examples of predicted time evolutions of average bright-state population according to one embodiment.

FIG. 8A illustrate examples of mean relative uncertainty for various values of S⁽⁰⁾ and MₜSₜ according to one embodiment.

FIG. 8B illustrates examples of mean relative errors in estimating η_{j,k} according to one embodiment.

FIG. 8C illustrates examples of the measurement times according to one embodiment.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

As the size of a quantum computer increases, parameters related to the quantum computer system need to be efficiently characterized with high accuracy to achieve high-fidelity quantum logic. In a trapped ion based quantum computer, the strength of entanglement between qubits (trapped ions) are mediated by motional modes of the ion chain, and thus characterizing the coupling strength between each ion and a motional mode (referred to as the Lamb-Dicke parameters) becomes essential. The embodiments described herein provide physical models that accurately predict both magnitude and sign of the Lamb-Dicke parameters when the motional modes are probed in parallel. The embodiments described herein further provide an improved characterization method that shortens the characterization time by more than an order of magnitude, when compared to that of the conventional method.

An overall system that is able to perform quantum computations using trapped ions will include a classical (digital) computer, a system controller, and a quantum processor. The classical computer performs supporting and system control tasks including selecting a quantum algorithm to be implemented on the quantum by use of a user interface, such as graphics processing unit (GPU), compiling the selected quantum algorithm into a series of universal logic gates, translating the series of universal logic gates into a series of pair-wise entangling gate operations to apply on the quantum processor, and computing amplitudes and detuning frequencies of laser pulses to cause the series of pair-wise entangling gate operations by use of a central processing unit (CPU). A software program for performing the task of decomposing and executing the quantum algorithms is stored in a non-volatile memory within the classical computer. The quantum processor includes trapped ions that are coupled with various hardware, including lasers to manipulate internal hyperfine states (qubit states) of the trapped ions and an acousto-optic modulator to read-out the internal hyperfine states (qubit states) of the trapped ions. The system controller receives from the classical computer the computed amplitudes and detuning frequencies of laser pulses at the beginning of running the selected algorithm on the quantum processor, controls various hardware associated with controlling any and all aspects used to run the selected algorithm on the quantum processor, and returns a read-out of the quantum processor (e.g., population of qubit states of the of trapped ions) and thus output of results of the quantum computation(s) at the end of running the algorithm to the classical computer to generate and output a solution to the selected quantum algorithm based on the processed results of the quantum computations.

### I. General Hardware Configurations

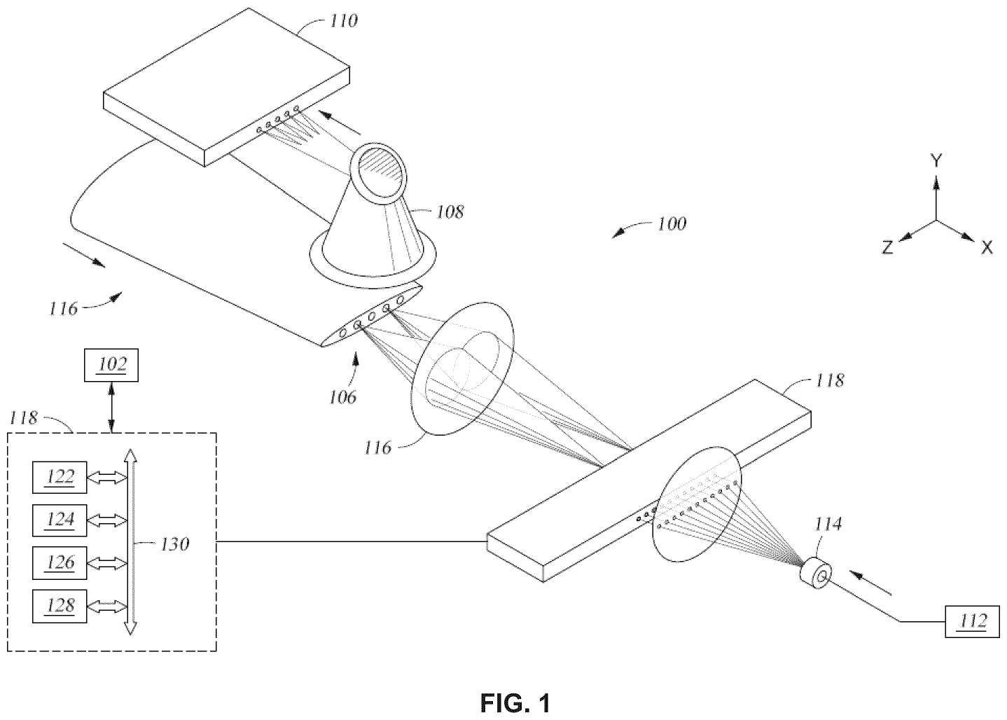

FIG. 1 is a schematic partial view of a trapped-ion quantum computing system 100, or simply the system 100 according to one embodiment. The system 100 can be representative of a hybrid quantum-classical computing system. The system 100 includes a classical (digital) computer 102 and a system controller 104. Other components of the system 100 shown in FIG. 1 are associated with a quantum processor, including a chain 106 of atomic ions (i.e., five shown as circles about equally spaced from each other) that are trapped and form a linear Coulomb crystal extending along the Z-axis. Each ion in the ion chain 106 is an ion having a nuclear spin I=½ and an electron spin S such that a difference between the nuclear spin I and the electron spin S is zero, such as a positive ytterbium ion, ¹⁷¹Yb⁺, a positive barium ion ¹³³Ba⁺, a positive cadmium ion ¹¹¹Cd⁺ or ¹¹³Cd⁺, which all have a nuclear spin I=½ and the ²S_{1/2} hyperfine states. In some embodiments, all ions in the ion chain 106 are the same species and isotope (e.g., ¹⁷¹Yb⁺). In some other embodiments, the ion chain 106 includes one or more species or isotopes (e.g., some ions are 171Yb⁺ and some other ions are ¹³³Ba⁺). In yet additional embodiments, the ion chain 106 may include various isotopes of the same species (e.g., different isotopes of Yb, different isotopes of Ba). The ions in the ion chain 106 are individually addressed with separate laser beams. The classical computer 102 includes a central processing unit (CPU), memory, and support circuits (or 1/O) (not shown). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 (or some other imaging device) for measurement of individual ions. Raman laser beams from a laser 112, which are provided along the X-axis, perform operations on the ions. A diffractive beam splitter 114 creates an array of Raman laser beams 116 that are individually switched using a multi-channel acousto-optic modulator (AOM) 118. The AOM 118 is configured to selectively act on individual ions by individually controlling emission of the Raman laser beams 116. A global Raman laser beam 120, which is non-copropagating to the Raman laser beams 116, illuminates all ions at once from a different direction. In some embodiments, rather than a single global Raman laser beam 120, individual Raman laser beams (not shown) can be used to each illuminate individual ions. The system controller (also referred to as a “RF controller”) 104 controls the AOM 118 and thus controls intensities, timings, and phases of laser pulses to be applied to trapped ions in the ion chain 106. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by the CPU 122 in order to perform various functionalities associated with receiving and analyzing data and controlling any and all aspects of the methods and hardware used to implement and operate the trapped-ion quantum computing system 100 discussed herein.

### II. Trapped-Ion Quantum Computer System

In a trapped-ion quantum computing system, such as the system 100, two internal states, such as the ²S_{1/2} hyperfine states, of an atomic ion are typically used as computational qubit states, denoted as |0 [symbol] and |1 [symbol] . The hyperfine ground state (i.e., [symbol] the lower energy state of the ²S_{1/2} hyperfine states) may be chosen to represent qubit state |0 [symbol] . Hereinafter, the terms “internal states,” “hyperfine states,” and “qubit states” may be interchangeably used to represent |0 [symbol] and |1 [symbol] . Further, the hyperfine states |0 [symbol] and |1 [symbol] may be referred to as “dark state” and “bright state,” respectively. Each ion may be cooled (i.e., kinetic energy of the ion may be reduced) to near the motional ground state for any motional mode with no phonon excitation by known laser cooling methods, such as Doppler cooling or resolved sideband cooling, and then the qubit state may be prepared in the dark state |0) by optical pumping. When many ions are trapped and form a linear Coulomb crystal as in the ion chain 106, the external motion of the ions (e.g., collective motion of the ions) can be quantized and approximated as a set of coupled quantum harmonic oscillators. The internal and external degrees of freedom (e.g., qubit states of individual ions and collective motions of the ions) of an ion chain consisting of N ions can be described by the Hamiltonian Ĥ₀

$${\hat{H}}_{0} = {\sum }_{j = 1}^{N} \frac{{ω}_{j}^{qbt}}{2} {\hat{σ}}_{j}^{z} + {\sum }_{k = 1}^{3 N} {ω}_{k} {\hat{a}}_{k}^{†} {\hat{a}}_{k} , \qquad ( 1 )$$

where ωⱼ^{qbt} is a carrier frequency (also referred to as “qubit frequency”) of ion j, corresponding to a frequency difference between the two qubit states of ion j, ωₖ is mode frequency of motional mode k, \hat{σ}ⱼ^{z} is the Pauli-z operator in the qubit space of ion j, and \hat{σ}ₖ and \hat{σ}ₖ^{†} are annihilation and creation operators for motional mode k.

A typical laser-induced multi-qubit gate operation among ions, for instance the Mølmer-Sørensen method, uses the laser electric field to couple the internal and external degrees of freedom of the participating ions in an ion chain. The interaction Hamiltonian of a classical oscillating electric field of frequency \tilde{ω}ⱼ (referred to as “laser coupling frequency”) that couples the qubit states of ion j within an N-ion chain, in the rotating frame with respect to the Hamiltonian Ĥ₀, can be written as

Ĥ_{I,j}=Ωⱼ\hat{σ}ⱼ⁺ exp[−i((\tilde{ω}ⱼ−ωⱼ^{qbt})t+ϕⱼ)]×exp[iΣₖ₌₁^{3N}η_{j,k}(âₖe^{-iω}^{ₖ}^{t}+âₖ^{†}e^{iω}^{ₖ}^{t})]+h.c., (2)

where \hat{σ}ⱼ⁺ is the raising operator of ion j, Ωⱼ is the qubit-state Rabi frequency (i.e., the coupling between the two qubit states of ion j), ϕⱼ is the laser phase, and η_{j,k} is the Lamb-Dicke parameter that quantifies the coupling strength between ion j and motional mode k. The laser phase may be chosen as ϕⱼ=0 for brevity. Typically, N′ motional modes of the total 3N motional modes (N′<3N) couple strongly to the lasers, whereas the rest of the motional modes contribute negligibly to the multi-qubit gate operation. For the multi-qubit gate operation to work faithfully and efficiently, the Lamb-Dicke parameter η_{j,k} and mode frequency ωₖ of these N′ motional modes need to be known with high accuracy.

### II.A Characterization of Lamb-Dicke Parameters

A conventional method for characterizing these parameters, the Lamb-Dicke parameter η_{j,k} and mode frequency ωₖ, is sideband spectroscopy using the blue-sideband (BSB) transition. To characterize the Lamb-Dicke parameter η_{j,k} of motional mode k on ion j and mode frequency ωₖ of motional mode k, laser pulses of a fixed time duration are applied while the laser coupling frequency \tilde{ω}ⱼ of each pulse is varied near the BSB resonant frequency ωⱼ^{qbt}+ωₖ. An initialization of ion j (e.g., laser cooling, such as Doppler cooling or resolved sideband cooling, and state-preparation procedure, such as optical pumping, to prepare ion j in the dark state |0)) is performed prior to the application of laser pulses. For each scanned laser coupling frequency \tilde{ω}ⱼ, the BSB transition near-resonantly couples |0,n [symbol] _{j,k} and |1,n+1 [symbol] _{j,k} where |a,b [symbol] _{j,k} denotes the composite state of qubit state |a [symbol] of ion j with a∈{0, 1} and motional Fock state |b [symbol] of motional mode k with phonon number b. At the end of each pulse, the bright-state population (i.e., probability of ion j in the bright state |1 [symbol] ), which non-trivially depends on the values of the Lamb-Dicke parameter η_{j,k} and mode frequency ωₖ, is measured.

Similar to other spectroscopy approaches, the conventional mode characterization method is designed to probe mode frequencies ωₖ. The embodiments described herein provide improvement over the conventional mode characterization method when more accurate and efficient characterization of the Lamb-Dicke parameters η_{j,k} is needed, especially because there are N×N′ different values of the Lamb-Dicke parameters η_{j,k} that need to be characterized.

To extract the Lamb-Dicke parameters η_{j,k}, the measured data of the bright-state population of ion j is fit to a model (referred to as a “baseline model” denoted by the superscript ⁽⁰⁾), which conventionally makes use of an approximated interaction Hamiltonian

$${\hat{H}}_{I , j , k} = {Ω}_{j} {\hat{σ}}_{j}^{+} {e}^{- i ( {\tilde{ω}}_{j} - {ω}_{j}^{qbt} ) t} \times exp [ i {η}_{j , k} ( {\hat{a}}_{k} {e}^{- i {ω}_{k} t} + {\hat{a}}_{k}^{†} {e}^{i {ω}_{k} t} ) ] + h . c . , \qquad ( 3 )$$

within the subspace spanned by the two composite states |0,0 [symbol] _{j,k} and |1,1 [symbol] _{j,k}. The time evolution operator can be written as

$${U}_{BSB}^{( 0 )} = [ \begin{matrix} & {u}_{11} & {u}_{12} \\ - & {u}_{12}^{*} & {u}_{11}^{*}\end{matrix} ] , \qquad ( 4 )$$

where * denotes the complex conjugate, and

$${u}_{11} = {e}^{- i {Δ}_{j , k} t / 2} [ cos ( {X}_{j , k} t ) + i \frac{{Δ}_{j , k}}{2 {X}_{j , k}} sin ( {X}_{j , k} t ) ] , \\ {u}_{12} = \frac{{Ω}_{j , k}^{( 0 )}}{{X}_{j , k}} {e}^{- i ( {Δ}_{j , k} t / 2 )} sin ( {X}_{j , k} t ) . \qquad ( 5 )$$

Here, t is the evolution time, Ω_{j,k}⁽⁰⁾=Ωⱼη_{j,k}e^{-η}^{_{j,k}}^{²}^{/2} is the effective Rabi frequency between the two composite states |0,0 [symbol] _{j,k} and |1,1 [symbol] _{j,k}, Δ_{j,k}:=\tilde{ω}ⱼ−ωⱼ^{qbt}−ωₖ is the detuning of the laser coupling frequency ωⱼ from the BSB transition, and X_{j,k}:=([Ω_{j,k}⁽⁰⁾]+Δ_{j,k}²/4)^{1/2}. Combining (4) and (5) then applying the resulting time evolution operator to the initial composite state |0,0 [symbol] _{j,k} the bright-state population is

$${P}_{j , k}^{( 0 )} ( t ) = \frac{{[ {Ω}_{j , k}^{( 0 )} ]}^{2}}{{[ {Ω}_{j , k}^{( 0 )} ]}^{2} + \frac{{Δ}_{j , k}^{2}}{4}} {sin}^{2} ( \sqrt{{[ {Ω}_{j , k}^{( 0 )} ]}^{2} + \frac{{Δ}_{j , k}^{2}}{4}} t ) , \qquad ( 6 )$$

which is used to fit to measured data of the bright-state population of ion j and extract the Lamb-Dicke parameters η_{j,k}.

### II.B Improvement Over Baseline Model

The baseline model is approximate for two major reasons: (i) spectator motional modes (i.e., the motional modes not being probed) are ignored, and (ii) the motional modes are assumed to be always prepared in the motional ground state. For more precise estimation of the bright-state population, contributions of the spectator motional modes, due to the non-zero spread of the ion's position wave packet and the off-resonant BSB transitions, as well as the effects of non-zero temperature, can be taken into account. It should also be noted that the conventional mode characterization method using (6) does not reveal the sign of the Lamb-Dicke parameter η_{j,k} relative to one another, which is critical for multi-qubit gate design and operation.

The methods according to the embodiments described herein are provided to improve the conventional mode characterization method with respect to the following aspects:
1. Parallelization—There are N×N′ different Lamb-Dicke parameters η_{j,k} in an N-ion chain with N′ motional modes strongly coupling to the lasers. Characterizing N×N′ different Lamb-Dicke parameters η_{j,k} one at a time would take O(N²) operations. To support a large-scale quantum computer, parallelization is necessary, bringing the complexity down to O(N).
2. Accuracy—To characterize the Lamb-Dicke parameters η_{j,k} with high accuracy, the effect of the coupling of ion j to other motional modes k′≠k needs to be taken into account. The coupling arises due to both the non-zero spread of the ion's position wave packet and the off-resonant BSB transitions.
3. Sign problem—The relative signs of the Lamb-Dicke parameter η_{j,k} need to be distinguished, while in (6) the bright-state population only depends on the magnitude of the Lamb-Dicke parameter η_{j,k} and not its sign.
4. Efficiency—Incorrect mode frequencies ωₖ as well as shot noise lead to incorrect characterization of the Lamb-Dicke parameter η_{j,k}. To reduce the uncertainties, considerably longer measurement is required.

Such improvements can be achieved by the following objectives:
Objective 1: Find effective models that better characterize the dynamics of bright-state populations of ions undergoing BSB transitions.
Objective 2: Explore methods and corresponding models that can distinguish the signs of the Lamb-Dicke parameters η_{j,k} relative to one another.
Objective 3: Find a more efficient, parallelized method that admits minimal measurement time while achieving the uncertainty in estimating the Lamb-Dicke parameters η_{j,k} below a target value.

### III. Improved Models

This section discusses various improved models that predict the bright-state populations of ions, all undergoing BSB transitions in parallel. These models are more accurate than the conventionally used baseline model in (6) in predicting the bright-state populations of ions, and thereby characterizing the Lamb-Dicke parameters η_{j,k} and mode frequencies ωₖ. Section III.A discusses three effects that occur in parallel BSB transitions that are not considered in the baseline model. Section III.B introduces a total of five models, progressively taking the effects discussed in Section III.A, and the combinations thereof, into account, culminating in the most sophisticated model at the end.

### III.A Effects

This section discusses three effects in parallel BSB transitions of ions.

Considering these effects in a model leads to more accurate characterization of Lamb-Dicke parameters η_{j,k}.

(a) Non-Zero Temperature

Even after using the most sophisticated cooling techniques, the motional modes are not likely to be in the absolute motional ground state. Therefore, the baseline model described in (4)-(6) is generalized to initial states of arbitrary phonon numbers n. The Rabi frequency between the two composite states |0,n [symbol] _{j,k} and |1,n+1 [symbol] _{j,k} assuming that composite states other than these two composite states do not affect the BSB transition, is given by

$$\begin{matrix}{Ω}_{j , k}^{( n )} = {Ω}_{j} \vert 〈 n + 1 \vert {e}^{i {η}_{j , k} ( {\hat{a}}_{k} + {\hat{a}}_{k}^{†} )} \vert n 〉 \vert \\ = {Ω}_{j} \frac{{η}_{j , k}}{\sqrt{n + 1}} {e}^{- {η}_{j , k}^{2} / 2} {L}_{n}^{1} ( {η}_{j , k}^{2} )\end{matrix} , \qquad ( 7 )$$

where Lₙ^{α} is the generalized-Laugerre polynomial.

This generalized Rabi frequency Ω_{j,k}⁽ⁿ⁾ can be used to evaluate the bright-state population undergoing BSB transition at non-zero temperature, as discussed below. For instance, P_{j,k}⁽ⁿ⁾(t) is defined as the bright-state population of ion j when the initial composite state is |0,n [symbol] _{j,k}, which is obtained by replacing the effective Rabi frequency Ω_{j,k}⁽⁰⁾ with the generalized Rabi frequency Ω_{j,k}⁽ⁿ⁾ in (6).
(b) Debye-Waller (DW) Effect

The spread of the ion's position wave packet associated with each mode manifests as a reduction in the Rabi frequency, widely known as the DW effect. Even when the motional modes are cooled to the motional ground state, the DW effect due to the zero-point fluctuation persists.

When motional mode k is being probed through ion j, the DW effect due to the spectator motional modes k′≠k leads to a reduction in the Rabi frequency between the two composite states |0,n [symbol] _{j,k} and |1,n [symbol] _{j,k}, given by

Ω_{j,k}^{(\vec{n})}=Ω_{j,k}⁽ⁿ^{ₖ}⁾Π_{k′≠k} [symbol] _{j,k′}(n_{k′}), (8)

where \vec{n} is the vector of initial phonon numbers n_{k′} of motional mode k′ (k′∈{1, 2, . . . , N′}) and [symbol] _{j,k′}(n_{k′}) is the average DW reduction factor of spectator motional mode k′ with an initial phonon number n_{k′}.

For an efficient characterization, each of the N ions is used to probe the assigned motional modes in parallel, which is repeated N′ times with different permutations of the motional modes to probe all N×N′ values of the Lamb-Dicke parameters η_{j,k}. In this case, each spectator motional mode k′ is also being probed through another ion j′(k′), thus phonon number of the motional mode k′ fluctuates between nₖ, and n_{k′+1}. Thus, the average DW reduction factor becomes

[symbol]

_{j,k′}(n_{k′})=αD_{j,k′}(n_{k′})+βD_{j,k′}(n_{k′}+1), (9)

where α,β≥0 (α+β=1) are the probabilities that ion j′(k′) and motional mode k′ are in the composite states |0,n_{k′} [symbol] _{j′(k′),k′} and |1,n_{k′}+1 [symbol] _{j′(k′),k′}, respectively, and

D_{j,k′}(n_{k′})=| [symbol] n_{k′}|e^{iη}^{_{j,k′}}^{(â}^{_{k′}}^{+â}^{_{k′}}^{^{†}}⁾|n_{k′} [symbol] |=e^{-η}^{_{j,k′}}^{²}^{/2} [symbol] ₙ_{_{k′}}(η_{j,k′}²), (10)

where [symbol] ₙ is the Laguerre polynomial.

In the case where motional mode k′ is resonantly probed for a sufficiently long evolution time, phonon number of motional mode k′ can be approximated as nₖ, half of the time and n_{k′}+1 for the other half. An exception is when ion j′(k′) is at the node of motional mode k′ (η_{j′(k′),k′}≈0) and the BSB transition of ion j′(k′) with respect to motional mode k′ is expected to not occur. Thus, in (9), the approximation

$$( α , β ) \approx \{ \begin{matrix}( 1 / 2 , 1 / 2 ) & if {η}_{j ′ ( k ′ ) , k ′} \geq {ϵ}_{η} , \\ ( 1 , 0 ) & if {η}_{j ′ ( k ′ ) , k ′} < {ϵ}_{η}\end{matrix} , \qquad ( 11 )$$

may be applied, where ϵ_{η} is a discriminator that determines if j′(k′) is at a nodal point of motional mode k′, typically chosen to be a small number (≈10⁻⁴).

Using (8)-(11), Eq. (6) can be further generalized to admit non-zero initial phonon numbers of all motional modes, by replacing the effective Rabi frequency Ω_{j,k}⁽⁰⁾ with the reduced Rabi frequency Ω_{j,k}^{(\vec{n})}. The resulting P_{j,k}^{(\vec{n})}(t) is the bright-state population of ion j undergoing parallel BSB transition, where initially all ions are in the dark state |0 [symbol] and the phonon number of motional mode k′ is n_{k′}, the k′-th element of \vec{n}.

(c) Cross-Mode Coupling

When ion j probes motional mode k, off-resonant BSB transitions with other motional modes k′≠k also occur. The resulting effects of the other motional modes on the qubit state is called the cross-mode coupling. While the cross-mode coupling can be reduced by using a Rabi frequency Ω_{j,k} that is much smaller than the detuning frequency Δ_{j,k′}, a smaller Rabi frequency leads to a slower BSB transition. Therefore, there is a tradeoff between reducing the error due to the cross-mode coupling and performing a shorter characterization measurement.

Cross-mode coupling can in principle be included in a model that simulates the time evolution of the entire Hamiltonian of N ions and N′ motional modes. However, the simulation time increases exponentially with the number N of ions. A more realistic approach is to thus include only the nearest-neighbor motional modes and the ions probing them in the simulation, limiting the simulated system size to at most three ions and three motional modes.

### III.B Five Improved Models

In the following, five models of the bright-state population of an ion undergoing parallel BSB transitions are discussed. The five models are improved from the baseline model in (6).

(a) Model 1: Debye-Waller (DW) Effect

Model 1 takes the DW effect into account while still assuming zero temperature. The average bright-state population P̅_{j,k′}(t) when the initial state is |0,0 [symbol] _{j,k} is given by

P̅_{j,k}(t)=P_{j,k}^{(\vec{0})}(t). (12)

Here, the bright-state population P_{j,k}^{(\vec{0})}(t) is obtained by (6), where the effective Rabi frequency Ω_{j,k}⁽⁰⁾ is replaced with the reduced Rabi frequency Ω_{j,k}^{(\vec{0})} in (8).

It should be noted that the reduced Rabi frequency Ω_{j,k}^{(\vec{0})} depends not only on the Lamb-Dicke parameter η_{j,k} but also on other Lamb-Dicke parameters η_{j,k′} (k′≠k). Model 1 is improved from the baseline model in that it addresses the effects of other motional modes k′≠k on the bright-state population of the ion probing motional mode k, while taking into account that all motional modes are being probed in parallel.

(b) Model 2: Non-Zero Temperature

Model 2 takes the non-zero-temperature effect into account, in addition to the DW effect taken into account in Model 1. By admitting multiple different initial phonon numbers with the distribution function p_{n̅}(nₖ), where n̅ is the average phonon number indicative of the non-zero temperature, the average bright-state population P̅_{j,k}(t) may be

P̅_{j,k}(t)=Σ_{\vec{n}}p_{n̅}(\vec{n})P_{j,k}^{(\vec{n})}(t), (13)

where p_{n̅}(\vec{n})=Πₖp_{n̅}(nₖ), and the bright-state population P_{j,k}^{(\vec{n})}(t) is found in (6), where the effective Rabi frequency Ω_{j,k}⁽⁰⁾ is replaced with the reduced Rabi frequency Ω_{j,k}^{(\vec{n})}. Here, for simplicity, thermal distributions are assumed to be the same average phonon number n for all motional modes, although generalization to arbitrary distributions is straightforward.

The summand in (13) is summed over a finite number of \vec{n}'s that satisfy p_{n̅}(\vec{n})>Pₜₕ for some threshold probability Pₜₕ. In the examples described herein, the threshold probability is set to be Pₜₕ=10⁻⁴ for the number of ions N≤7. Each evaluation of the bright-state population P_{j,k}^{(\vec{n})}(t) is parallelizable, so the conventional computation time does not necessarily increase as the number of \vec{n}'s increases. In other examples, \vec{n} can be randomly sampled from the distribution p_{n̅}(\vec{n}), especially for N≥7 as the number of all \vec{n}'s to be considered becomes very large. In this case, the accuracy of the distribution is determined by the threshold probability Pₜₕ, and the sampling precision is determined by the number of samples drawn.

(c) Model 3: Time-Dependent DW (TDDW) Effect

Model 3 further takes time-dependency of the DW reduction factor into account. This is because for each motional mode k being probed through ion j, a spectator motional mode k′≠k is also being probed through another ion j′(k′)≠j, and its phonon number fluctuates between nₖ, and n_{k′}+1 over time as being probed. The TDDW reduction factor is given by

[symbol]

_{j,k′}(t,n_{k′})=(1−P_{j′(k′),k′}⁽ⁿ^{_{k′}}⁾(t))×D_{j,k′}(n_{k′})+P_{j′(k′),k′}⁽ⁿ^{_{k′}}⁾(t)×D_{j,k′}(n_{k′}+1), (14)

where 1−P_{j′(k′),k′}⁽ⁿ^{_{k′}}⁾(t) and P_{j′(k′),k′}⁽ⁿ^{_{k′}}⁾(t) are the probabilities that ion j′(k′) and motional mode k′ are in the composite states |0,n_{k′} [symbol] _{j′(k′),k′} and |1,n_{k′}+1 [symbol] _{j′(k′),k′} at time t, respectively. Here, P_{j′(k′),k′}⁽ⁿ^{_{k′}}⁾(t) can be evaluated using (6), where the effective Rabi frequency σ_{j′(k′),k′}⁽⁰⁾, is replaced with the reduced Rabi frequency Ω_{j′(k′),k′}⁽ⁿ^{_{k′}}⁾ given by (7).

Now, to evaluate the bright-state population P_{j,k}^{(\vec{n})}(t) with the TDDW effect considered, this time-dependent DW reduction factor replaces the average DW reduction factor in (8), which makes the reduced Rabi frequency Ω_{j,k}^{(\vec{n})} time dependent as well. Therefore, the time evolution from 0 to t may be divided into short time steps, and the time evolution operator in (4) and (5) are applied, while the reduced Rabi frequency Ω_{j,k}^{(\vec{n})} is updated at each time step to solve for the bright-state population P_{j,k}^{(\vec{n})}(t). A weighted average of the bright-state population P_{j,k}^{(\vec{n})}(t) over the phonon numbers \vec{n} as in (13) provides the average bright-state population P̅_{j,k}(t).

(d) Model 4: Nearest Neighbor (NN).

Model 4 takes the NN motional modes of the probed motional mode and their assigned ions into account. In other words, a subspace of the probed motional mode k, its NN motional modes k−1 and k+1 (where the motional modes are ordered with increasing mode frequency), and their assigned ions j(k), j(k−1), and j(k+1) (two ions, two motional modes for k=1 and N′) is considered.

The interaction Hamiltonian describing the subspace is

$${\hat{H}}_{NN} = i ℏ {\sum }_{j ′ ∈ J} {Ω}_{j ′} ( {\hat{σ}}_{j ′}^{+} {e}^{- i ( {\tilde{ω}}_{j ′} - {ω}_{j ′}^{qbt} ) t} {\prod }_{k ″ ∉ K} {\overline{𝒟}}_{j ′ , k ″} ( {n}_{k ″} ) \times {\sum }_{k ′ ∈ K} exp [ i {η}_{j ′ , k ′} ( {\hat{a}}_{k ′} {e}^{- i {ω}_{k ′} t} + {\hat{a}}_{k ′}^{†} {e}^{i {ω}_{k ′} t} ) ] ) + h . c . , \qquad ( 15 )$$

where J={j(k−1), j(k), j(k+1)}, K={k−1, k, k+1}. The initial composite state is |0,nₖ₋₁ [symbol] _{j(k-1),k-1}⊗|0,nₖ [symbol] _{j(k),k}⊗|0,nₖ₊₁ [symbol] _{j(k+1),k+1}. By taking the matrix elements corresponding to resonant transitions and evaluating the time evolution operator of this Hamiltonian from time 0 to t, the average bright-state population P̅_{j(k),k}(t) is obtained as in (13).

Evaluating the time evolution operator of the three-ion, three-mode Hamiltonian in (15) takes substantially longer time than simply evaluating trigonometric functions and polynomials as in previous models. However, this model includes the NN motional modes, so its accuracy suffers less from the cross-mode coupling. It should be noted that it properly captures the quantum interference between the qubit states and the motional modes beyond a single-ion, single-mode model. The predicted bright-state population is sensitive to the sign of the Lamb-Dicke parameter η_{j,k} relative to the Lamb-Dicke parameter η_{j,k±1}.

(e) Model 5: TDDW+NN.

Model 5 takes the TDDW effect discussed in (c) Model 3 into the NN model in (d) Model 4. This is done by replacing the average DW reduction factor in (15) with the TDDW factor in (14).

### IV. Methods

In this section, two methods, a “basic method” and an “improved method,” for characterizing the Lamb-Dicke parameters η_{j,k} and mode frequencies ωₖ according to the embodiments described herein are provided. The measured bright-state populations of N ion qubits undergoing BSB transitions can have different sensitivities to the Lamb-Dicke parameters for different methods. As there are N×N′ different values of the Lamb-Dicke parameters η_{j,k} parallelization of the measurement becomes a necessity. The conventional mode characterization method is primarily designed solely for probing mode frequencies ωₖ. The basic method, discussed in the following, is a modified version of the conventional mode characterization method to probe the values of the Lamb-Dicke parameters η_{j,k} in parallel. The improved method can more accurately and quickly determine the Lamb-Dicke parameters η_{j,k}.

As the methods described herein are designed for characterizing the Lamb-Dicke parameters η_{j,k} with high accuracy, rough estimates of the Lamb-Dicke parameters prior to performing the methods are assumed. Estimates of η_{j,k} within an order of magnitude and those of mode frequencies ωₖ within a few kHz may suffice.

### IV. A Basic Method

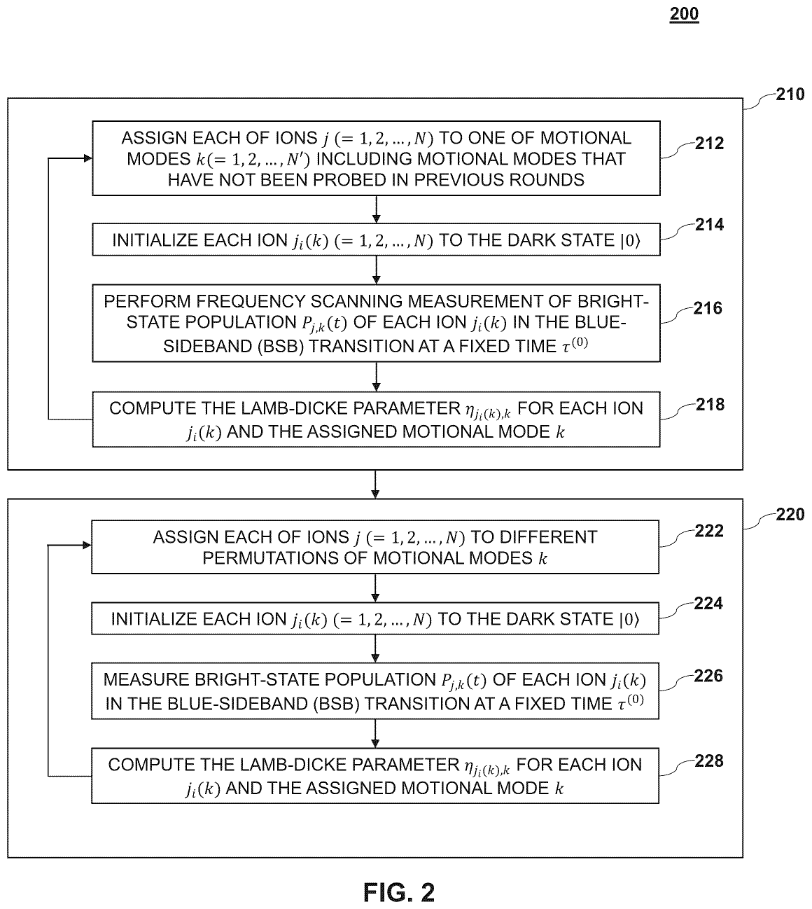

FIG. 2 depicts a flowchart illustrating a basic method 200 of characterizing the Lamb-Dicke parameters η_{j,k} that quantifies the coupling strength between ion j and motional mode k. Here, N ions in an ion chain are labeled by j, and N′ motional modes of the ion chain that strongly couple to lasers are labeled by k. The number of the Lamb-Dicke parameters η_{j,k} to be determined is thus N×N′.

The basic method 200 includes two steps. The first step in block 210 includes measuring mode frequencies ωₖ of all of N′ motional modes by frequency scanning measurement using N ions, and simultaneously determining N′ of the N×N′ Lamb-Dicke parameters ηⱼ_{ᵢ}_{(k),k}. In a typical case, the number N of ions is equal to the number N′ of motional modes, and thus all of the N′ motional modes are each assigned an ion that is to be probed. In the case where the number N′ of motional modes is greater than the number N of ions, this first step is repeated ┌N′/N┐ rounds such that all of the N′ motional modes are each assigned an ion that is to be probed at least in one round. In an i-th round (i=1, . . . ┌N′/N┐), mode frequency ωₖ of motional mode k and the Lamb-Dicke parameter ηⱼ_{ᵢ}_{(k),k} for the motional mode k and ion jᵢ(k) are determined together. Here, ┌⋅┐ denotes the least integer greater than or equal to the argument, and jᵢ(k) denotes the ion used to probe the motional mode k in the i-th round.

The second step in block 220 includes determining the (N−1)×N′ remaining Lamb-Dicke parameters ηⱼ_{ᵢ}_{(k),k}. The second step is repeated N′−┌N′/N┐ rounds.

Specifically, the i-th round of block 210 starts with sub-block 212, in which ions j (=1, 2, . . . , N) are each assigned to one of probe motional modes k(=1, 2, . . . , N′) including the motional modes that have not been probed in previous rounds. The ion that is assigned to probe motional mode k in the i-th round is denoted as jᵢ(k). Among N′ motional modes that are strongly coupled to the lasers, N ions are assigned to probe N motional modes, and no ions are assigned to probe (N′−N) motional modes in sub-block 212.

The i-th round of block 210 continues with sub-block 214, in which each ion jᵢ(k) (=1, 2, . . . , N) is initialized to the dark state |0). In the examples described herein, the dark state |0) is the hyperfine ground state of the ion jᵢ(k). Each ion jᵢ(k) may be initialized (i.e., cooled such that kinetic energy of the ion is reduced), by known laser cooling methods, such as Doppler cooling or resolved sideband cooling, to near the motional ground state for any motional mode with no phonon excitation, and then the qubit state prepared in the hyperfine ground state |0) by optical pumping.

The i-th round of block 210 continues with sub-block 216, in which a frequency scanning measurement of bright-state population P_{j,k}(t) of each ion jᵢ(k) in the blue-sideband (BSB) transition at a fixed time τ⁽⁰⁾ is performed. Each ion jᵢ(k) (=1, 2, . . . , N) is excited by laser pulses while laser coupling frequency \tilde{ω}ⱼ_{ᵢ}₍ₖ₎ is varied (i.e., frequency scanning measurement) near the expected BSB-resonant frequency ωⱼ_{ᵢ}₍ₖ₎^{qbt}+ωₖ, and the bright-state population P_{j,k}(t) of each ion jᵢ(k) is measured, where ωⱼ_{ᵢ}₍ₖ₎^{qbt} is the qubit frequency of ion jᵢ(k) and ωₖ is an estimated value of mode frequency of motional mode k. Since the bright-state population P_{j,k}(t) at a fixed time τ⁽⁰⁾ is maximized at P_{j,k}^{Max}(τ⁽⁰⁾) when the detuning frequency Δ_{j,k} (=\tilde{ω}ⱼ_{ᵢ}₍ₖ₎−ωⱼ_{ᵢ}₍ₖ₎^{qbt}−ωₖ) from the BSB transition frequency ωⱼ_{ᵢ}₍ₖ₎^{qbt}+ωₖ is zero, mode frequency ωₖ is measured as the laser coupling frequency ωⱼ_{ᵢ}₍ₖ₎ that maximizes the bright-state population P_{j,k}(t) minus the qubit frequency ωⱼ_{ᵢ}₍ₖ₎^{qbt} of ion jᵢ(k) (i.e., \tilde{ω}ⱼ_{ᵢ}₍ₖ₎−ωⱼ_{ᵢ}₍ₖ₎^{qbt}).

The i-th round of block 210 continues with sub-block 218, in which the Lamb-Dicke parameter ηⱼ_{ᵢ}_{(k),k} for each ion jᵢ(k) and the assigned motional mode k is computed. The Lamb-Dicke parameter ηⱼ_{ᵢ}_{(k),k} can be computed by fitting the maximized bright-state population P_{j,k}^{Max}(τ₍₀₎) that is measured in sub-block 216 to the average bright-state population P̅_{j,k}(τ⁽⁰⁾) that is derived using any of the models, Models 1-5, described above.

Sub-blocks 212-218 are performed on N ions in parallel in each round (i=1, . . . ┌N′/N┐), and repeated ┌N′/N┐ rounds until all of the N′ motional modes have been probed.

It should be noted that in order to measure mode frequency ωₖ accurately, the mode assignment j=jᵢ(k) (i=1, . . . ┌N′/N┐) in sub-block 212, the fixed time τ⁽⁰⁾, and the qubit-state Rabi frequency Ωⱼ all need to be prudently chosen such that the bright-state population P_{j,k}^{Max}(τ⁽⁰⁾) at zero detuning frequency is sufficiently large.

The i-th round of block 220 starts with sub-block 222, in which ions j (1, 2, . . . , N) are each assigned to one of motional modes k. In sub-block 222, the ions are assigned to different permutations of the motional modes (e.g., different combinations of ions j and motional mode k). The ion that is assigned to the motional mode k in the i-th round is denoted as jᵢ(k).

The i-th round of block 220 continues with sub-block 224, in which each ion jᵢ(k) (=1, 2, . . . , N) is initialized to the dark state |0). This initialization of the ions is the same as sub-block 214.

The i-th round of block 220 continues with sub-block 226, in which bright-state population P_{j,k}(t) of each ion jᵢ(k) in the blue-sideband (BSB) transition is measured at a fixed time τ⁽⁰⁾. No frequency scanning measurement is performed in sub-block 226. Each ion jᵢ(k) (=1, 2, . . . , N) is excited by laser pulses while laser coupling frequency ωⱼ_{ᵢ}₍ₖ₎ is fixed at ωⱼ_{ᵢ}₍ₖ₎^{qbt}+ωₖ where mode frequency ωₖ is known from the first step in block 210.

The i-th round of block 220 continues with sub-block 228, in which the Lamb-Dicke parameter ηⱼ_{ᵢ}_{(k),k} for each ion jᵢ(k) and the assigned motional mode k is computed. The Lamb-Dicke parameter ηⱼ_{ᵢ}_{(k),k} can be computed by fitting the maximized bright-state population P_{j,k}^{Max}(τ⁽⁰⁾) that is measured in sub-block 226 to the average bright-state population P̅_{j,k}(τ⁽⁰⁾) that is derived using any of the models, Models 1-5, described above.

In each round (i=┌N′/N┐+1, . . . , N′), sub-blocks 222-228 are performed on N ions in parallel, thus N of the N′×(N−1) remaining Lamb-Dicke parameters ηⱼ_{ᵢ}_{(k),k} are determined. To determine asub-blocks 222-228 are repeated N′−┌N′/N┐ rounds until all of the N′×(N−1) remaining Lamb-Dicke parameters ηⱼ_{ᵢ}_{(k),k} are determined.

### IV. B Improved Method

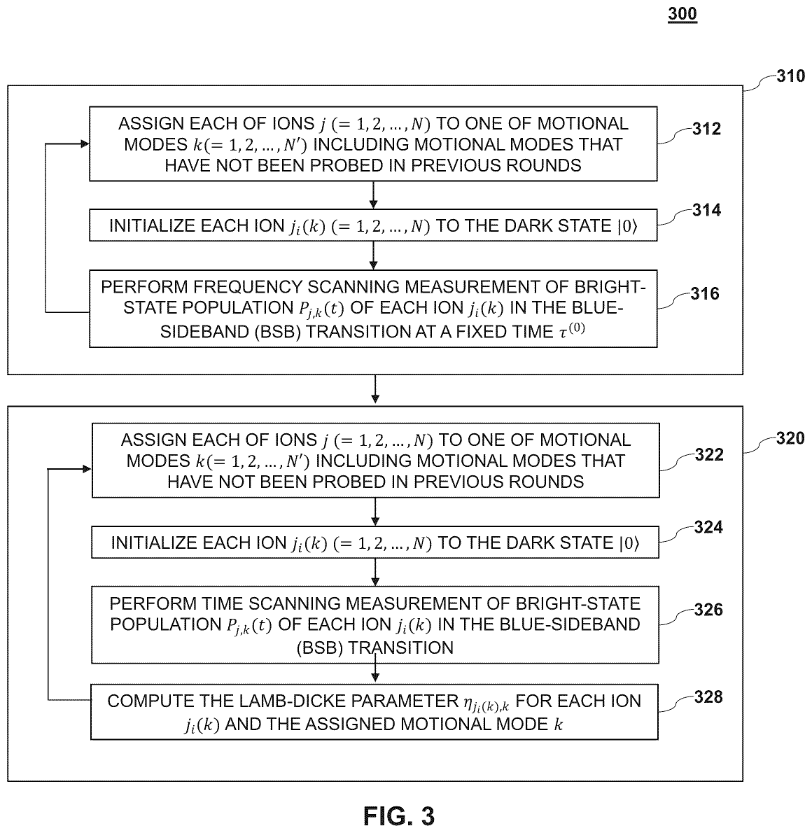

FIG. 3 depicts a flowchart illustrating an improved method 300 of characterizing the Lamb-Dicke parameters η_{j,k} that quantifies the coupling strength between ion j and motional mode k. Here, N ions in an ion chain are also labeled by j, and N′ motional modes of the ion chain that strongly couple to lasers are labeled by k. The number of the Lamb-Dicke parameters η_{j,k} to be determined is thus N×N′.

The improved method 300 also includes two steps. The first step in block 310 is a frequency scanning measurement to compute mode frequencies ωₖ of all of N′ motional modes using N ions, as in the first step in block 210 of the basic method 200. However, in the first step in block 310, the Lamb-Dicke parameters η_{j,k} are not computed. The first step is repeated ┌N′/N┐ rounds such that all of the N′ motional modes are each assigned an ion for probing at least in one round.

The second step in block 320 is a time scanning measurement of bright-state population P_{j,k}(t) to compute the Lamb-Dicke parameters η_{j,k}. The second step is repeated N′ rounds.

Specifically, the i-th round (i=1, . . . ┌N′/N┐) of block 310 starts with sub-block 312, in which ions j (=1, 2, . . . , N) are each assigned to one of probe motional modes k(=1, 2, . . . , N′) including the motional modes that have not been probed in previous rounds. Sub-block 312 is the same as sub-block 212 of the basic method 200.

The i-th round of block 310 continues with sub-block 314, in which each ion jᵢ(k) (=1, 2, . . . , N) is initialized to the dark state |0). This initialization of the ions is the same as sub-block 214 of the basic method 200.

The i-th round of block 310 continues with sub-block 316, in which a frequency scanning measurement of a bright-state population P_{j,k}(t) of each ion jᵢ(k) in the blue-sideband (BSB) transition at a fixed time τ⁽⁰⁾ is performed. Each ion jᵢ(k) (=1, 2, . . . , N) is excited by laser pulses while laser coupling frequency ωⱼ_{ᵢ}₍ₖ₎ is varied (i.e., frequency scan) near the expected BSB-resonant frequency ωⱼ_{ᵢ}₍ₖ₎^{qbt}+ωₖ, and the bright-state population P_{j,k}(t) of each ion jᵢ(k) is measured, where ωⱼ_{ᵢ}₍ₖ₎^{qbt} is the qubit frequency of ion jᵢ(k) and ωₖ is an estimated value of mode frequency of motional mode k. Since the bright-state population P_{j,k}(t) at a fixed time τ⁽⁰⁾ is maximized at P_{j,k}^{Max}(τ⁽⁰⁾) when the detuning frequency Δ_{j,k}(=\tilde{ω}ⱼ_{ᵢ}₍ₖ₎−ωⱼ_{ᵢ}₍ₖ₎−ωₖ) from the BSB transition frequency ωⱼ_{ᵢ}₍ₖ₎^{qbt}+ωₖ is zero, mode frequency ωₖ is measured as the laser coupling frequency ωⱼ_{ᵢ}₍ₖ₎ that maximizes the bright-state population P_{j,k}(t) minus the qubit frequency ωⱼ_{ᵢ}₍ₖ₎^{qbt} of ion jᵢ(k) (i.e., \tilde{ω}ⱼ_{ᵢ}₍ₖ₎−ωⱼ_{ᵢ}₍ₖ₎^{qbt}). Sub-block 316 is the same as sub-block 216 of the basic method 200.

Sub-blocks 312-316 are performed on N ions in parallel in each round (i=1, . . . ┌N′/N┐), and repeated ┌N′/N┐ rounds until all of the N′ motional modes have been probed.

The i-th round of block 320 starts with sub-block 322, in which ions j (1, 2, . . . , N) are each assigned to one of motional modes k (=1, 2, . . . , N′). In sub-block 322, the ions are assigned to different permutations of the motional modes (e.g., different combinations of ions j and motional mode k). The ion that is assigned to probe the motional mode k in the i-th round is denoted as jᵢ(k).

The i-th round of block 320 continues with sub-block 324, in which in which each ion jᵢ(k) (=1, 2, . . . , N) is initialized to the dark state |0 [symbol] . This initialization of the ions is the same as sub-block 224 of the basic method 200.

The i-th round of block 320 continues with sub-block 326, in which a time scanning measurement of bright-state population P_{j,k}(t) of each ion jᵢ(k) in the blue-sideband (BSB) transition at a fixed laser coupling frequency \tilde{ω}ⱼ_{ᵢ}₍ₖ₎ is performed. Each ion jᵢ(k) (=1, 2, . . . , N) is excited by laser pulses while laser coupling frequency \tilde{ω}ⱼ_{ᵢ}₍ₖ₎ is fixed at ωⱼ_{ᵢ}₍ₖ₎^{qbt}+ωₖ (and thus at a fixed detuning frequency Δ_{j,k}), and the bright-state population P_{j,k}(t) of each ion jᵢ(k) is measured at various evolution times τ=τ₁, . . . , τ_{M}_{ₜ}, where ωⱼ_{ᵢ}₍ₖ₎^{qbt} is the qubit frequency of ion jᵢ(k) and mode frequency ωₖ is known from the first step in block 310.

The i-th round of block 320 continues with sub-block 328, in which the Lamb-Dicke parameter ηⱼ_{ᵢ}_{(k),k} for each ion jᵢ(k) and the assigned motional mode k is computed. The Lamb-Dicke parameter ηⱼ_{ᵢ}_{(k),k} can be computed by fitting the measured bright-state population P_{j,k}(t) to the average bright-state population P̅_{j,k}(Tₘ) (m=1, . . . Mₜ) that is derived using any of the models, Models 1-5, described above.

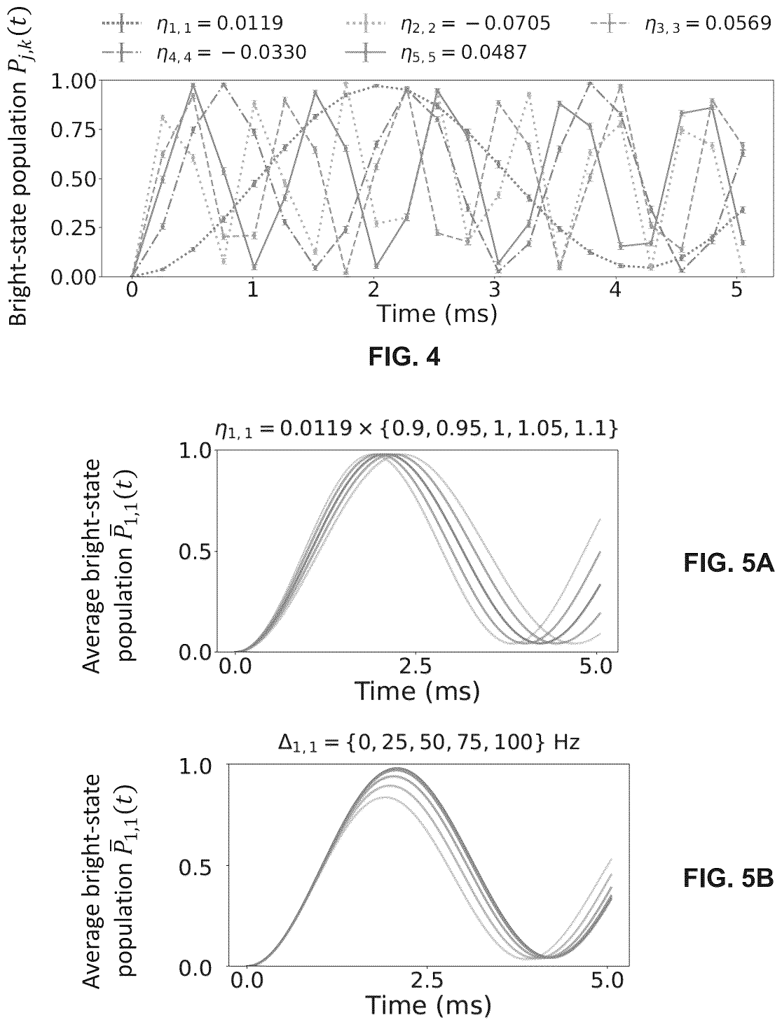

FIG. 4 illustrates examples of bright-state population P_{j,k}(t) undergoing perfectly resonant (Δ_{j,k}=0) BSB transitions in parallel at various evolution times. In this example, the number N of ions is set to be equal to the number N′ of motional modes that are strongly coupled to the lasers (N=N′=5), the qubit-state Rabi frequency is chosen as Ωⱼ=2π×10 kHz ∀j=1, . . . 5, and each mode k is probed through ion j(k)=k. The bright-state population P_{j,k}(t) was recorded at Mₜ=20 equally spaced time-stamps (evolution times at which the bright-state population P_{j,k}(t) was recorded) τₘ, and then fitted into a model for determining η_{j,k}. Error bars show the shot noise for 1000 shots.

In each round (i=1, . . . N′), sub-blocks 322-328 are performed on N ions in parallel and repeated N′ rounds, exhaustively pairing N ions with N′ motional modes and all of N′×N Lamb-Dicke parameters ηⱼ_{ᵢ}_{(k),k} are determined.

### IV. C Measurement Timescale

In the methods described above, a trapped-ion quantum computer goes through a cycle of cooling of ions, qubit state preparation, BSB transition, and measurement of bright-state population of ions. Times scales of the cooling, state preparation, and measurement may be in the order of 10 ms, 10 μs, and 100 μs, respectively. The BSB transition requires time in the order of milliseconds, as the qubit-state Rabi frequency needs to be sufficiently small in order to suppress the cross-mode coupling.

In a case where the number N of ions equals the number N′ of motional modes that are strongly coupled to the lasers (N′=N), which corresponds to a commonly used laser-alignment setting, a total time T⁽⁰⁾ required for characterizing the Lamb-Dicke parameters η_{j,k} and mode frequencies ωₖ according to the basic method 200 is then

T⁽⁰⁾=M_{Δ}⁽⁰⁾S⁽⁰⁾\tilde{τ}⁽⁰⁾+(N′−1)S⁽⁰⁾\tilde{τ}⁽⁰⁾, (16)

where M_{Δ}⁽⁰⁾ is the number of detuning frequencies considered in the first step in block 210, S⁽⁰⁾ is the number of shots per data point, \tilde{τ}⁽⁰⁾ is the cycle time that includes the BSB-transition time τ⁽⁰⁾, and the superscript ⁽⁰⁾ indicates that these values are for the basic method 200. Total time T required for characterizing the Lamb-Dicke parameters η_{j,k} and mode frequencies ωₖ according to the improved method is

T=M_{Δ}S_{Δ}\tilde{τ}_{Δ}+N′SₜΣₘ₌₁^{M}^{ₜ}\tilde{τ}ₘ, (17)

where M_{Δ} (Mₜ) is the number of detuning frequencies (time-stamps) in the frequency (time) scan, S_{Δ} (Sₜ) is the number of shots for each frequency (time) scan, and \tilde{τ}_{Δ} (\tilde{τ}ₘ) is the cycle time for each frequency (time) scanning measurement that includes the BSB-transition time τ_{Δ} (Δₘ).

The lower bounds of the parameters above are determined by the target accuracy in the measurement of the Lamb-Dicke parameters η_{j,k}. In particular, the minimum required M_{Δ}⁽⁰⁾ (M_{Δ}) and τ⁽⁰⁾ (T_{Δ}) for the baseline method (improved method 300) are determined by the upper bound of the uncertainty in mode frequencies ωₖ, required to reach the target accuracy in the Lamb-Dicke parameters η_{j,k}.

In the basic method 200, when the uncertainty in mode frequency ωₖ is large, the uncertainty in the Lamb-Dicke parameters η_{j,k} also becomes large, as both parameters directly affect the bright-state population P̅_{j,k}(τ⁽⁰⁾). This may be contrasted to the η_{j,k}-estimation process in the improved method 300. Unlike a single value bright-state population P̅_{j,k}(τ⁽⁰⁾) in the baseline case, in time scanning measurement in the improved method 300, a set of the bright-state population P̅_{j,k}(t) is measured at various evolution times t. When fitting the time-series data to a model, the Lamb-Dicke parameter η_{j,k} and the detuning frequency Δ_{j,k} can be estimated in a distinguishable way, namely, the Lamb-Dicke parameter η_{j,k} only affects the frequency of the oscillations of the bright-state population P̅_{j,k}(t), while the detuning frequency Δ_{j,k} affects both its frequency and amplitude, for example, as shown FIGS. 5A and 5B. This separation of signals for the different parameters to be estimated allows a larger uncertainty in, e.g., mode frequency ωₖ when estimating the Lamb-Dicke parameter η_{j,k} to a certain accuracy. Targeting the same accuracy in the Lamb-Dicke parameter η_{j,k} in turn leads to significantly shorter frequency scanning measurement time when compared to that of the basic method 200.

FIGS. 5A and 5B illustrate examples of time evolution of the average bright-state population P̅_{1,1}(t) in BSB transition for various values of the Lamb-Dicke parameter η_{1,1} and detuning frequency Δ_{1,1} of the laser coupling frequency \tilde{ω}ⱼ from the BSB transition, respectively. The qubit-state Rabi frequency Ω₁ of ion 1 is chosen as Ω₁=2π×10 kHz. The bold lines are η_{1,1}=0.0119×1 and Δ_{1,1}=0 Hz, respectively. η_{1,1} only affects the frequency of oscillation, while Δ_{1,1} affects both its frequency and amplitude. This allows more accurate measurement of η_{j,k} in the presence of uncertainty in mode frequencies. It should be noted that the average bright-state population P̅_{1,1}(t) is more sensitive to the value of η_{1,1} when the average bright-state population P̅_{1,1}(t) is close to 0.5, rather than close to zero or one. The improved method 300 uses the entire the average bright-state population P̅_{j,k}(t) curve that always includes points near 0.5. In contrast, in the basic method 200 where N Lamb-Dicke parameters are measured in parallel, it is challenging to find the pulse length τ⁽⁰⁾ such that the average bright-state population P̅_{j,k}(τ⁽⁰⁾)≈0.5 for all N qubits. Therefore, it is expected that with the same total number of shots, the improved method 300 leads to a smaller average uncertainty in η_{j,k}.

Fitting the measured bright-state populations into Models 1-5 is a non-trivial task, as the average bright-state population P̅_{j,k}(t) depends not solely on the Lamb-Dicke parameter η_{j,k}, but also on other Lamb-Dicke parameters of the spectator motional modes, including the nearest-neighbor motional modes. A naive approach would be to fit the average bright-state populations P̅_{j′,k′}(t) (j′=1, . . . N, k′=1, . . . N′) altogether, where all N×N′ Lamb-Dicke parameters η_{j′,k′} are fit parameters. However, for large N, fitting N×N′ parameters at once requires too long of a conventional-computation time for practical use. Therefore, a fitting routine may be more than one iterations where the η_{j′,k′} ((j′,k′)≠(j,k)) values from initial guess or previous iteration of fitting is used in the model. The fitting routine is highly parallelized so that the runtime of the computational part of the characterization method is scalable with large number of ions N.

It should be noted that although more accurate and efficient estimation of the Lamb-Dicke parameters is discussed in this section, the methods described herein can be readily used for better mode frequency estimation as well. For instance, fitting the bright-state populations of ions measured at various laser coupling frequencies ωⱼ into Models 1-5 can lead to more accurate estimation of mode frequencies ωₖ.

### V. Examples

In this section, examples are shown to demonstrate that the three objectives of efficient mode characterization, stated in Sec. II, can be achieved with the improved models and the methods described herein. More specifically, (i) comparison of the accuracy of Models 1-5 to the baseline model in measuring the Lamb-Dicke parameters η_{j,k}, (ii) demonstration that Model 4 can distinguish the relative signs of the Lamb-Dicke parameters η_{j,k}, and (iii) requirement of significantly shorter characterization measurement time by the improved method 300 than the basic method 200 for a given target accuracy in η_{j,k} estimation are shown.

To perform numerical tests, the parallel BSB-transition measurement is numerically simulated. The BSB Hamiltonian in the interaction picture is given by

Ĥ_{I}=Σⱼ₌₁^{N}Ĥ_{I,j}, (18)

where Ĥ_{I,j} is found in (2). In the examples shown in Section V, the number of motional modes N′ is set to be equal to the number of ions N in an ion chain (N′=N), which agrees with a typical laser alignment. The time evolution operator implied by Ĥ_{I} is applied to all initial states ⊗_{k′=1}^{N}|0,n_{k′} [symbol] _{j′(k′),k′}, where ion j′(k′) is the ion assigned for mode k′, and the vector of phonon numbers \vec{n} satisfies p_{n̅}(\vec{n})>pₜₕ, as discussed above. The average phonon number n is set to be 0.05 (n̅=0.05) for all motional modes and the threshold probability is set to be 10⁻⁴ (pₜₕ=10⁻⁴). The composite state of qubit state of ion j(k) and motional Fock state of motional mode k at time t is projected onto the qubits' subspace and yields the bright-state population P_{j(k),k}^{(\vec{n})}(t) for all motional modes k. Finally, the weighted average of the bright-state population P̅_{j(k),k}(t) is computed as in (13), which are then fitted to the previously discussed models to test accuracy of the respective models. It should be noted the Hilbert space dimension grows exponentially with the number N of ions, thus the models are tested up to N=7.

### V.A Accuracy

First, using numerical simulation of the bright-state population, the baseline model and Models 1-5 are compared in their performance in adequately capturing the qubit-population evolution. Here, as an example it is assumed that all ions are simultaneously driven with the same qubit-state Rabi frequency: Ωⱼ=Ω₀ ∀j=1, . . . N. The bright-state populations are recorded at Mₜ=20 equally spaced time-stamps τₘ. The longest time-stamp is chosen as τ_{M}_{ₜ}=2.5\sqrt{N}(Ω₀| [symbol] Δkₓ [symbol] /\sqrt{2m [symbol] ω_{mode} [symbol]}|)⁻¹, where [symbol] Δkₓ [symbol] is the wavevector difference between the two Raman laser beams projected to the mode direction and [symbol] ω_{mode} [symbol] is a rough estimate of mode frequencies, such that the longest BSB transition with respect to the center-of-mass mode undergoes roughly five Rabi half-cycles for all N and Ω₀.

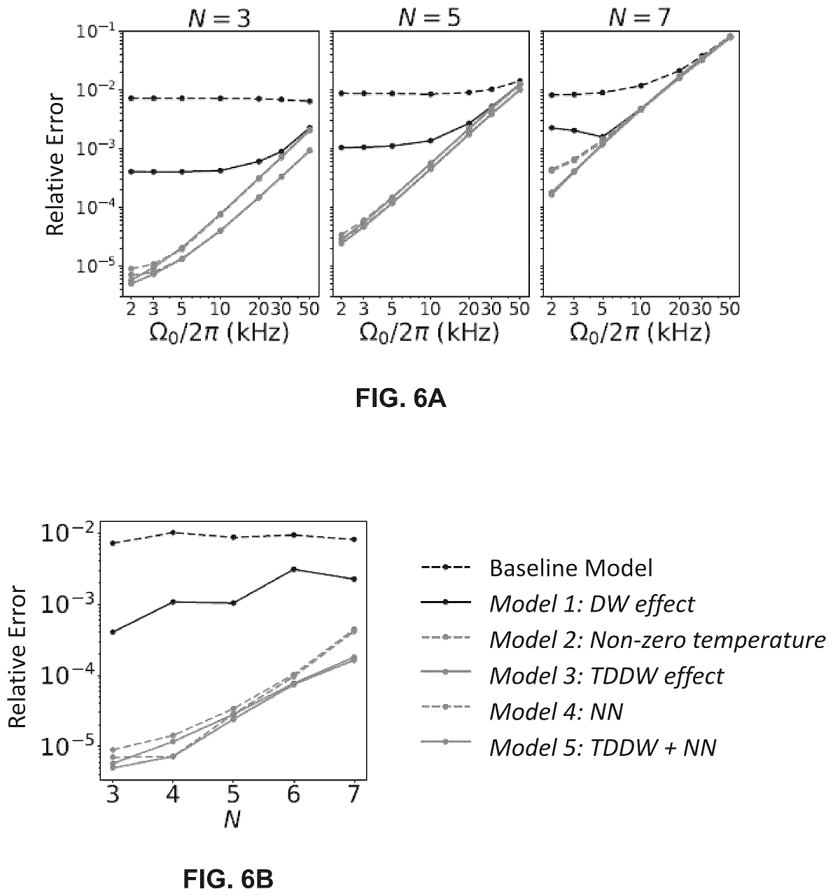

FIGS. 6A and 6B illustrate examples of the mean relative errors in estimating the Lamb-Dicke parameters η_{j,k}, obtained from using various models, as a function of qubit-state Rabi frequency no and the number N of ions with qubit-state Rabi frequency no fixed to 2π×2 kHz, respectively. The labels are in the order of baseline and Models 1-5, described in Sec. III. Here the relative error is defined as |(η_{j,k}−η_{j,k}^{(est)})/η_{j,k}|, where η_{j,k}^{(est)} is the estimated Lamb-Dicke parameter from fitting to the model. Excluding the Lamb-Dicke parameters corresponding to a node (η_{j,k}<10⁻⁴), the errors are averaged over all N² values of η_{j,k} for N≤5, and averaged over N values η_{j=k,k} measured in parallel for N>5. In general, Models 1-5 show significant improvement in the accuracy of estimating η_{j,k} compared to the baseline model. In particular, relative error of size less than 10⁻³ can only be achieved by using the improved models. Including both the DW effect from the spectator motional modes and the non-zero temperature effect significantly reduces the error, especially when Ω₀ is small and the cross-mode coupling is not dominant.

Models 2-5 show a power-law behavior, relative error being proportional to Ω₀². It should be noted that a perturbative regime is used as an example, where the Rabi frequency Ω_{j,k}∝Ω₀ is much smaller than the detuning frequency Δ_{j,k}, from motional modes k′≠k not being probed by ion j. The observed power law is reminiscent of the dominance of the cross-mode-coupling error in this regime.

It can been seen that including the NN motional modes into the model reduces error from the cross-mode coupling. Model 4 and 5 have noticeably smaller errors than Model 2 and 3 for N<5. However, for longer ion chains, the errors do not have as much difference. In the case where, for example, η_{j,k±1} are smaller than η_{j,k±2}, the effects of the modes k±2 can be comparable to or larger than those of the NN modes k±1 on the error in measuring η_{j,k}. For such cases, the NN model can be revised to include the modes with significant effects, at the cost of longer computation time for fitting.

The models with the TDDW effect included achieve the highest accuracy. For instance, in FIG. 6B, when N=7, the errors of Models 3 and 5 are 2.5 times smaller than those of Models 2 and 4. The TDDW effect may be more important for characterizing the Lamb-Dicke parameters with higher accuracy in longer ion chains.

It should be noted that a fixed physical distance between neighboring ions is assumed. Thus, as the number N of ions increases, the spacing between mode frequencies decreases, which leads to more severe cross-mode coupling for a fixed qubit-state Rabi frequency.

### V.B Sign Problem

The sign of the Lamb-Dicke parameter η_{j,k} relative to other Lamb-Dicke parameters determines the gate-pulse design on many trapped-ion quantum computers, hence affecting directly the quantum-computational fidelity. Unfortunately, conventional mode-characterization methods cannot distinguish the sign of the Lamb-Dicke parameter η_{j,k} because the qubit population is independent of the sign in the baseline model in (6). Here, it is shown that the sign of the Lamb-Dicke parameter η_{j,k} can be distinguished using the NN model (Model 4).

To start, in order to distinguish the sign of η_{j,k} using BSB transitions, more than one ion needs to be considered, as the sign of the Lamb-Dicke parameter η_{j,k} is well-defined only when the relative motion between different ions is described. It should also be noted that with a single mode, for different signs of η_{j,k}, ions move in different relative directions, but the qubit populations undergo exactly same evolution. Only when at least two ions and two modes are considered simultaneously, the sign of η_{j,k} determines whether the symmetry of two ions' participation in one mode is the same or the opposite from that in the other mode, a difference that affects the qubit populations.

By driving two ions to couple to two different modes in parallel via illuminating the two ions with the same two-tone beam, where each tone is resonant to the respective mode frequency, BSB transitions to the two modes simultaneously occur on the two ions. The predicted evolutions, one with the same symmetry and the other with the opposite symmetry, become drastically different from each other. This allows determination of which symmetry, hence the sign of the Lamb-Dicke parameter η_{j,k} is the correct one directly from the signal generated by the measurement.

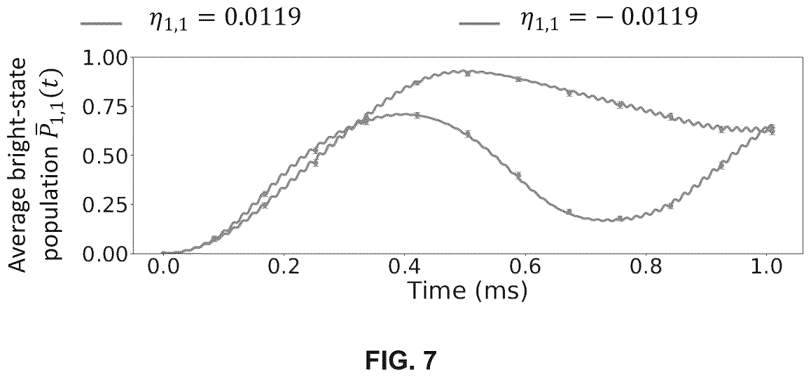

FIG. 7 illustrates examples of predicted time evolutions of average bright-state population P̅_{1,1}(t), where the sign of the Lamb-Dicke parameter η_{1,1}=±0.0119 is varied with respect to predetermined values of η_{1,2}=0.0335, η_{2,1}=−0.0521, and η_{2,2}=−0.0705 for N=5. Both the first and second ions are driven at two laser coupling frequencies \tilde{ω}₁, \tilde{ω}₂, which are resonant to the first and second modes with frequencies ω₁ and ω₂, respectively. Qubit-state Rabi frequencies of the first and second ions are 2π×30 kHz and 2π×9 kHz, respectively, so as to roughly match the resulting Rabi frequency between |0,0 [symbol] _{1,1} and |1,1 [symbol] _{1,1} and that between |0,0 [symbol] _{1,2} and |1,1 [symbol] _{1,2}.

It can be seen that the population curves when the Lamb-Dicke parameter η_{1,1}=±0.0119 are clearly distinguishable, and are accurately predicted by the NN model (Model 4). This shows that the sign of the Lamb-Dicke parameter η_{j,k} can reliably be distinguished by inducing all four possible BSB transitions between two ions and two modes simultaneously, when carefully choosing parameters and comparing the observed evolution with that predicted by the NN model.

### V.C Characterization Measurement Time

The characterization measurement time of the basic method 200 and the improved method 300 given by (16) and (17), respectively, depends on the following parameters: (i) M_{Δ}⁽⁰⁾ in the basic method 200 and M_{Δ} in the improved method 300, the number of detuning frequencies scanned in the frequency scan, (ii) S⁽⁰⁾ in the basic method 200, S_{Δ} and Sₜ in the improved method 300, the number of shots, and (iii) \tilde{τ}⁽⁰⁾ in the base method, and \tilde{τ}_{Δ} and \tilde{τ}ᵢ in the improved method 300, the cycle time. These parameters (i)-(iii) are to be minimized, whenever applicable, while delivering a pre-determined target accuracy in estimating the Lamb-Dicke parameter η_{j,k}. It should be noted that achieving the target accuracy is primarily hindered by the shot noise and the uncertainties in other parameters, such as ωₖ.

To be consistent with Sec. V.A, Mₜ is fixed at Mₜ=20, and τ_{M}_{ₜ}=2.5\sqrt{N}(Ω₀| [symbol] kₓ [symbol] /{square root over (2m [symbol] (ω_{mode} [symbol] )}|)⁻¹, where N=5. Also, to compare the total measurement times on an equal footing, S_{Δ} is set as S_{Δ}=MₜSₜ for the improved method and compare the value with S⁽⁰⁾ of the basic method, which uses τ₍₀₎=τ_{M}_{ₜ}/2. Therefore, the knobs that can turn are Ω₀, S⁽⁰⁾, and M_{Δ}⁽⁰⁾ for the basic method 200, and Ω₀, Sₜ, M_{Δ}, and τ_{Δ} for the improved method 300.

First, the number of shots S⁽⁰⁾ of the basic method 200 and Sₜ of the improved method 300 required to reach a small uncertainty in the Lamb-Dicke parameter η_{j,k} are computed. Here, the simulated bright-state populations are fitted, with uncertainties given by the photon and phonon shot noise combined, using Model 2, assuming perfect knowledge of mode frequencies ωₖ. Here, Ω₀=2π×10 kHz is used, although the effect of shot noise is not significantly affected by Ω₀.

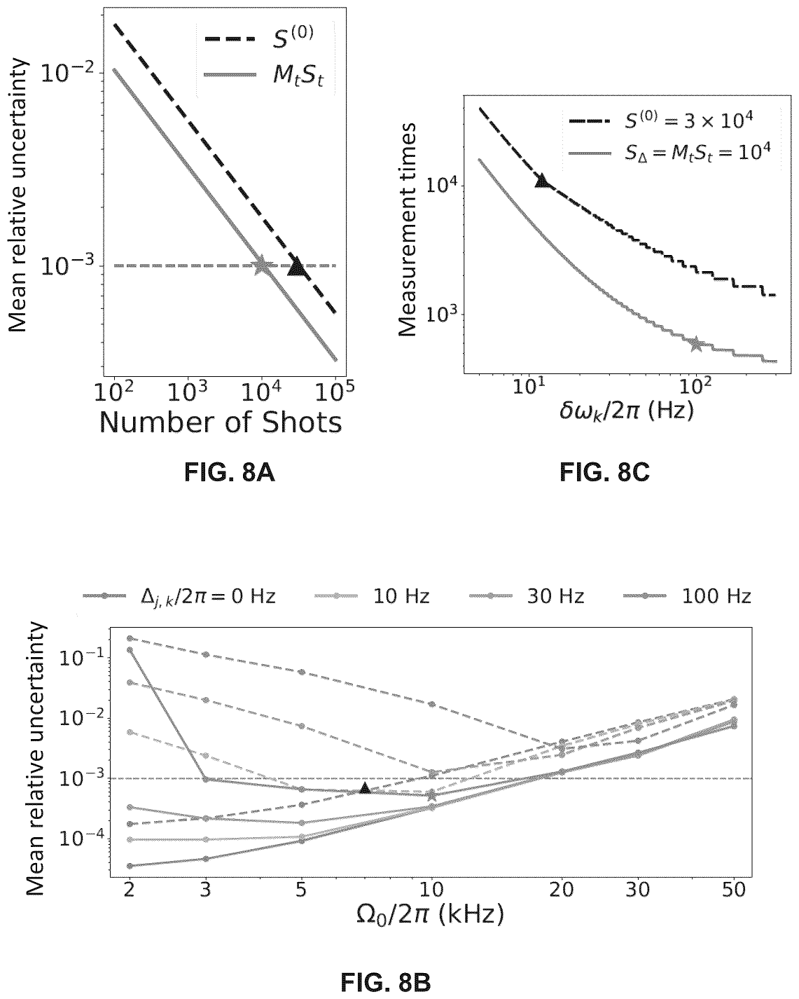

FIG. 8A illustrates examples of the mean relative uncertainty for various values of S⁽⁰⁾ and MₜSₜ. The uncertainty is proportional to the inverse of square root of the number of shots. When S⁽⁰⁾=MₜSₜ, the improved method always achieves a smaller uncertainty in η_{j,k} than the basic method. As explained in Sec. IV, the improved method measures the entire P_{j,k}(t) curve, which includes points where the qubit populations are maximally sensitive to the value of η_{j,k}. This allows a smaller uncertainty in η_{j,k}, compared to that obtained by the basic method, as measurement at a fixed time-stamp τ⁽⁰⁾ cannot make all populations of N qubits sensitive to η_{j,k}. In particular, to reach an average uncertainty below 10⁻³, the basic method 200 {improved method 300} requires S⁽⁰⁾=3×10⁴ {MₜSₜ=10⁴}, marked as ▴ {*}.

Next, the qubit-state Rabi frequency no is computed, which determines the BSB-transition time τ⁽⁰⁾ {τᵢ}, and the frequency scanning parameters M_{Δ}⁽⁰⁾ {M_{Δ} and τ_{Δ}} of the basic method 200 {improved method 300}, required to measure η_{j,k} to within a target accuracy. The bright-state populations are fitted, with various values of no and detuning frequencies Δ_{j,k}, once again using Model 2, but this time without assuming knowledge of Δ_{j,k}. Here, the numbers of shots marked in FIG. 8A are used, but it is assumed that the measured qubit probabilities are correct without shot noise.

The qubit population depends on |Δ_{j,k}/Ω₀|² up to the leading order in (6), so the error due to nonzero Δ_{j,k} decreases as no increases. However, when Ω₀ is too large, error due to the cross-mode coupling becomes dominant. From this tug-of-war, the set of parameters Ω₀ and δωₖ can be assumed. The set of parameters Ω₀ and δωₖ allows the measurement of η_{j,k} with a prescribed target accuracy, where δωₖ is the upper bound of |Δ_{j,k}|, or the maximum allowed uncertainty in mode frequencies. For the basic method, there is an additional constraint for δωₖ that the difference between the qubit populations at time τ⁽⁰⁾ when μⱼ=ωₖ and μⱼ=ωₖ+δωₖ exceeds the lower bound of the sum of shot noise. For the improved method, the frequency scan's BSB-transition time τ_{Δ} is not constrained as such, so δωₖ directly determines τ_{Δ} from the condition analogous to above. Also, δωₖ determines the number of detuning frequencies M_{Δ}⁽⁰⁾ and M_{Δ} as ┌δω_{k,prior}/2δωₖ┐, where δω_{k,prior} is the range of mode frequencies that is assumed to be given as a prior.

FIG. 8B illustrates examples of the mean relative errors in estimating η_{j,k} as a function of Ω₀. Considered are multiple Δ_{j,k} values. Using this figure, when provided with a pre-determined target accuracy in η_{j,k} measurement, the values of Ω₀ and δωₖ that will meet the target accuracy can be determined. For example, if the relative uncertainty to be lower than 10⁻³ is desired, a reasonable choice for the basic method 200 {improved method 300} would be Ω₀/2π=7 {10} kHz and δωₖ/2π=12 {100} Hz, marked as ▴ {*}. As explained in Sec. IV, the improved method fits the entire P̅_{j,k}(t) curve, which has distinguishable effects from varying η_{j,k} and Δ_{j,k}, allowing for a more accurate measurement in the presence of larger detuning frequency, compared to the basic method that fits the population at a single time-stamp. The chosen value of δωₖ for the improved method leads to τ_{Δ}=0.57 ms. Also, δωₖ for the basic method 200 {improved method 300} method gives M_{Δ}⁽⁰⁾=43 {M_{Δ}=5}, where it is assumed the width of prior δω_{k,prior}=2π×1 kHz.

Now, with all the parameters of the methods determined, comparison is made between the characterization measurement time of the basic method 200 and the improved method 300 given in (16) and (17). As a concrete example, it is assumed the times for cooling, state preparation, and state detection are, respectively, 4 ms, 100 μs, and 150 μs, which are added to the BSB-transition time to yield the cycle time for each shot. Table 1 shows the set of parameters of the two methods. Overall, in order to achieve the relative measurement uncertainty of the order of 10⁻³ in estimating η_{j,k} for a five-ion chain, the characterization measurement time is T=586 s for the improved method, which is about 19 times shorter than T⁽⁰⁾=1.11×10⁴ s for the basic method. The savings of the improved method come from allowing fewer shots and less precision in the frequency scan.

TABLE 1
Parameters of the basic method 200 (left) and the improved method
300 (right) that achieve the relative uncertainty in η_{j, k} in the order of
10⁻³ for a five-ion chain. [symbol] is the average over i = 1, . . . Mₜ.
According to (16) and (17), the characterization measurement times
of the basic method 200 and the improved method 300 are T⁽⁰⁾ =
1.11 × 10⁴ s and T = 586 s, respectively.

| \tilde{τ}⁽⁰⁾ | S⁽⁰⁾ | M_{Δ}⁽⁰⁾ | \tilde{τ}_{Δ} | S_{Δ} | M_{Δ} | [symbol] \tilde{τ}ᵢ [symbol] | Sₜ | Mₜ |
|---|---|---|---|---|---|---|---|---|
| 7.86 ms | 3 × 10⁴ | 43 | 4.82 ms | 10⁴ | 5 | 6.90 ms | 500 | 20 |

Finally, to distinguish the advantage of requiring fewer shots and less frequency scanning precision, FIG. 8C illustrates examples of the measurement times of the two methods for various values of δωₖ. This emphasizes that allowing larger uncertainty δωₖ in the mode frequencies significantly reduces the characterization measurement time for the improved method.

### VI Tradeoff Between Basic Method and Improved Method

The problem of efficient motional-mode characterization with high accuracy boils down to an optimization over multiple parameters that are correlated by various trade offs. For example, using a smaller laser power (thus smaller Ω₀) reduces the errors due to cross-mode coupling, at the cost of requiring longer BSB-transition time and better frequency scanning precision.

The choice of methods and models also can be viewed in light of the trade offs. For example, a parallelized method reduces the complexity from O(N²) to O(N), at the cost of bringing additional considerations into the model, such as the DW effect from the other modes being probed in parallel, which is time-dependent to be precise. In general, a more accurate model can be used at the cost of longer conventional-computation time. To exploit this trade off, a highly parallelized and efficient algorithm for the fitting routine may be explored, performing the conventional-computation part of the method relatively fast, especially relevant for long ion chains where the computation tends to slow down.

Another important trade off relevant to trapped ions is the spacing between mode frequencies versus the physical distance between neighboring ions. Smaller distance between neighboring ions leads to larger spacing between mode frequencies, which allows smaller errors in measuring η_{j,k} as the cross-mode-coupling effects are reduced This can alleviate the exponential increase of error with N shown in FIG. 6B, which assumes a fixed distance between neighboring ions. However, a smaller inter-ion distance also leads to larger optical crosstalk, as the laser beam width cannot be arbitrarily small.

In the embodiments described herein, the methods for motional mode characterization are provided. In particular, the methods are based on effective physical models that describe the dynamics of ions in an ion chain and motional modes of the ion chain more accurately than the conventional physical model, thereby enabling accurate and efficient characterization of the motional modes. The methods described herein utilize a time scanning measurement that allows faster and more accurate characterization of motional modes, and parallelism in that motional modes are probed by a plurality of ions simultaneously for faster accurate characterization of motional modes, as compared with the conventional method.

Appendices A, B, C, and D are attached and all their contents are considered part of this application, and are therefore incorporated into this application.

While the foregoing is directed to specific embodiments, other and further embodiments may be devised without departing from the basic scope thereof, and the scope thereof is determined by the claims that follow.

1. A method of using an ion trap quantum computer, comprising:
performing a first measurement of bright-state population of each ion in an ion chain comprising a plurality of ions at a fixed time duration, the each ion coupled to one of motional modes of the ion chain, while varying laser coupling frequency for coupling the each ion and the one of the motional modes;
computing mode frequency of the one of the motional mode based on a frequency at which the bright-state population of the each ion measured in the first measurement is maximized;
computing coupling strength of the each ion and the one of the motional modes by fitting the maximized bright-state population of the each ion measured in the first measurement to a value of the bright-state population computed based on the computed mode frequency of the one of the motional modes and non-zero temperature effect of the motional modes;
performing a second measurement of bright-state population of each ion in the ion chain at a fixed time duration, each ion coupled to one of the motional modes, to which the each ion has not been coupled in the first measurement, while the laser coupling frequency for coupling the each ion and the one of the motional modes is fixed; and
computing coupling strength of the each ion and the one of the motional mode by fitting the bright-state population of the each ion measured in the second measurement to a value of the bright-state population computed based on the computed mode frequency of the one of the motional modes and non-zero temperature effect of the motional modes.

2. The method of claim 1, further comprising:
selecting, by a processor in a digital computer, a quantum algorithm to be implemented on the plurality of ions;
compiling, by the processor in the digital computer, the selected quantum algorithm into a series of universal logic gates;
translating, by the processor in the digital computer, the series of universal logic gates into a series of pair-wise entangling gate operations to apply on the plurality of ions in the ion chain;
computing, by the processor in the digital computer, amplitudes and detuning frequencies of laser pulses to cause the series of pair-wise entangling gate operations based on the computed coupling strength of motional mods and ions;
applying, by a system controller, the laser pulses having the computed amplitudes and detuning frequencies to the plurality of ions in the ion chain;
measuring, by the system controller, population of qubit states of the plurality of ions in the ion chain; and
processing, by the processor in the digital computer, quantum information corresponding to the qubit states of the plurality of ions in the ion chain based on the measured population of the qubit states; and
generating and outputting, by the processor in the digital computer, a solution to the selected quantum algorithm based on the processed results of the quantum computations.

3. The method of claim 1, further comprising:
initializing each ion in the ion chain in the hyperfine ground state of the each ion prior to the first measurement and the second measurement of the each ion.

4. The method of claim 1, wherein
the first measurement of all ions in the ion chain are simultaneously performed.

5. The method of claim 1, wherein
the second measurement of all ions in the ion chain are simultaneously performed.

6. The method of claim 1, wherein
the computing of the coupling strength of an ion in the ion chain and a motional mode of the ion chain is further based on Debye-Waller effect of the ion.

7. The method of claim 1, wherein
the computing of the coupling strength of an ion in the ion chain and a motional mode of the ion chain is further based on cross-mode coupling effect of the motional modes of the ion chain.

8. A method of using an ion trap quantum computer, comprising:
performing, by a system controller, a first measurement of bright-state population of each ion in an ion chain comprising a plurality of ions at a fixed time duration, the each ion coupled to one of motional modes of the ion chain, while varying laser coupling frequency for coupling the each ion and the one of the motional modes;
computing, by a processor in a digital computer, mode frequency of the one of the motional mode based on a frequency at which the bright-state population of the each ion measured in the first measurement is maximized;
computing, by the processor in the digital computer, coupling strength of the each ion and the one of the motional modes by fitting the maximized bright-state population of the each ion measured in the first measurement to a value of the bright-state population computed based on the computed mode frequency of the one of the motional modes and non-zero temperature effect of the motional modes;
performing, by the system controller, a second measurement of bright-state population of each ion in the ion chain at a fixed time duration, each ion coupled to one of the motional modes, to which the each ion has not been coupled in the first measurement, while the laser coupling frequency for coupling the each ion and the one of the motional modes is fixed;
computing, by the processor in the digital computer, coupling strength of the each ion and the one of the motional mode by fitting the bright-state population of the each ion measured in the second measurement to a value of the bright-state population computed based on the computed mode frequency of the one of the motional modes and non-zero temperature effect of the motional modes,
selecting, by the processor in the digital computer, a quantum algorithm to be implemented on the plurality of ions;
compiling, by the processor in the digital computer, the selected quantum algorithm into a series of universal logic gates;
translating, by the processor in the digital computer, the series of universal logic gates into a series of pair-wise entangling gate operations to apply on the plurality of ions in the ion chain;
computing, by the processor in the digital computer, amplitudes and detuning frequencies of laser pulses to cause the series of pair-wise entangling gate operations based on the computed coupling strength of motional mods and ions;
applying, by a system controller, the laser pulses having the computed amplitudes and detuning frequencies to the plurality of ions in the ion chain;
measuring, by the system controller, population of qubit states of the plurality of ions in the ion chain; and
processing, by the processor in the digital computer, quantum information corresponding to the qubit states of the plurality of ions in the ion chain based on the measured population of the qubit states; and
generating and outputting, by the processor in the digital computer, a solution to the selected quantum algorithm based on the processed results of the quantum computations.

9. A method of using an ion trap quantum computer, comprising:
performing a first measurement of bright-state population of each ion in an ion chain comprising a plurality of ions at a fixed time duration, the each ion coupled to one of motional modes of the ion chain, while varying laser coupling frequency for coupling the each ion and the one of the motional modes;
computing mode frequency of the one of the motional mode based on a frequency at which the bright-state population of the each ion measured in the first measurement is maximized;
performing a second measurement of bright-state population of each ion in the ion chain at a plurality of time durations, each ion coupled to one of the motional modes, while the laser coupling frequency for coupling the each ion and the one of the motional modes is fixed; and
computing coupling strength of the each ion and the one of the motional mode by fitting the bright-state population of the each ion measured in the second measurement to a value of the bright-state population computed based on the computed mode frequency of the one of the motional modes and non-zero temperature effect of the motional modes.

10. The method of claim 9, further comprising:
selecting, by a processor in a digital computer, a quantum algorithm to be implemented on the plurality of ions;
compiling, by the processor in the digital computer, the selected quantum algorithm into a series of universal logic gates;
translating, by the processor in the digital computer, the series of universal logic gates into a series of pair-wise entangling gate operations to apply on the plurality of ions in the ion chain;
computing, by the processor in the digital computer, amplitudes and detuning frequencies of laser pulses to cause the series of pair-wise entangling gate operations based on the computed coupling strength of motional mods and ions;
applying, by a system controller, the laser pulses having the computed amplitudes and detuning frequencies to the plurality of ions in the ion chain;
measuring, by the system controller, population of qubit states of the plurality of ions in the ion chain; and
processing, by the processor in the digital computer, quantum information corresponding to the qubit states of the plurality of ions in the ion chain based on the measured population of the qubit states; and
generating and outputting, by the processor in the digital computer, a solution to the selected quantum algorithm based on the processed results of the quantum computations.

11. The method of claim 9, further comprising:
initializing each ion in the ion chain in the hyperfine ground state of the each ion prior to the first measurement and the second measurement of the each ion.

12. The method of claim 9, wherein
the first measurement of all ions in the ion chain are simultaneously performed.

13. The method of claim 9, wherein
the second measurement of all ions in the ion chain are simultaneously performed.

14. The method of claim 9, wherein
the computing of the coupling strength of an ion in the ion chain and a motional mode of the ion chain is further based on Debye-Waller effect of the ion.

15. The method of claim 9, wherein
the computing of the coupling strength of an ion in the ion chain and a motional mode of the ion chain is further based on cross-mode coupling effect of the motional modes of the ion chain.

16. A method of using an ion trap quantum computer, comprising:
performing, by a system controller, a first measurement of bright-state population of each ion in an ion chain comprising a plurality of ions at a fixed time duration, the each ion coupled to one of motional modes of the ion chain, while varying laser coupling frequency for coupling the each ion and the one of the motional modes;
computing, by a processor in a digital computer, mode frequency of the one of the motional mode based on a frequency at which the bright-state population of the each ion measured in the first measurement is maximized;
performing, by system controller, a second measurement of bright-state population of each ion in the ion chain at a plurality of time durations, each ion coupled to one of the motional modes, while the laser coupling frequency for coupling the each ion and the one of the motional modes is fixed;
computing, by the processor in the digital computer, coupling strength of the each ion and the one of the motional mode by fitting the bright-state population of the each ion measured in the second measurement to a value of the bright-state population computed based on the computed mode frequency of the one of the motional modes and non-zero temperature effect of the motional modes;
selecting, by the processor in the digital computer, a quantum algorithm to be implemented on the plurality of ions;
compiling, by the processor in the digital computer, the selected quantum algorithm into a series of universal logic gates;
translating, by the processor in the digital computer, the series of universal logic gates into a series of pair-wise entangling gate operations to apply on the plurality of ions in the ion chain;
computing, by the processor in the digital computer, amplitudes and detuning frequencies of laser pulses to cause the series of pair-wise entangling gate operations based on the computed coupling strength of motional mods and ions;
applying, by a system controller, the laser pulses having the computed amplitudes and detuning frequencies to the plurality of ions in the ion chain;
measuring, by the system controller, population of qubit states of the plurality of ions in the ion chain; and
processing, by the processor in the digital computer, quantum information corresponding to the qubit states of the plurality of ions in the ion chain based on the measured population of the qubit states; and
generating and outputting, by the processor in the digital computer, a solution to the selected quantum algorithm based on the processed results of the quantum computations.

17. A quantum computing system, comprising:
an ion chain comprising a plurality of ions, each ion in the ion chain having two hyperfine states defining a qubit;
a system controller; and
a classical computer comprising a processor and non-volatile memory having a number of instructions stored therein which, when executed by the processor, causes the quantum computing system to perform operations comprising:
performing, by the system controller, a first measurement of bright-state population of each ion in the ion chain at a fixed time duration, the each ion coupled to one of motional modes of the ion chain, while varying laser coupling frequency for coupling the each ion and the one of the motional modes;
computing, by the processor, mode frequency of the one of the motional mode based on a frequency at which the bright-state population of the each ion measured in the first measurement is maximized;
performing, by the system controller, a second measurement of bright-state population of each ion in the ion chain, each ion coupled to one of the motional modes, while the laser coupling frequency for coupling the each ion and the one of the motional modes is fixed; and
computing, by the processor, coupling strength of each ion in the ion chain and one of the motional modes of the ion chain based on based on the bright-state population measured in the first measurement, the bright-state population measured in the second measurement, the computed mode frequency of the one of the motional modes, and non-zero temperature effect of the motional modes.

18. The quantum computing system of claim 17, wherein the second measurement is performed at a fixed time duration.

19. The quantum computing system of claim 17, wherein the second measurement is performed at plurality of time durations.

20. The quantum computing system of claim 17, wherein the operations further comprise:
selecting, by a processor in a digital computer, a quantum algorithm to be implemented on the plurality of ions;
compiling, by the processor in the digital computer, the selected quantum algorithm into a series of universal logic gates;
translating, by the processor in the digital computer, the series of universal logic gates into a series of pair-wise entangling gate operations to apply on the plurality of ions in the ion chain;
computing, by the processor in the digital computer, amplitudes and detuning frequencies of laser pulses to cause the series of pair-wise entangling gate operations based on the computed coupling strength of motional mods and ions;
applying, by a system controller, the laser pulses having the computed amplitudes and detuning frequencies to the plurality of ions in the ion chain;
measuring, by the system controller, population of qubit states of the plurality of ions in the ion chain; and
processing, by the processor in the digital computer, quantum information corresponding to the qubit states of the plurality of ions in the ion chain based on the measured population of the qubit states; and
generating and outputting, by the processor in the digital computer, a solution to the selected quantum algorithm based on the processed results of the quantum computations.

21. The quantum computing system of claim 17, wherein the operations further comprise:
initializing each ion in the ion chain in the hyperfine ground state of the each ion prior to the first measurement and the second measurement of the each ion.

22. The quantum computing system of claim 17, wherein
the computing of the coupling strength of an ion in the ion chain and a motional mode of the ion chain is further based on at least one of Debye-Waller effect of the ion and cross-mode coupling effect of the motional modes of the ion chain.
